(19) United States
(12) Patent Application Publication
(10) Pub. No.: US 2010/0025393 A1
(43) Pub. Date: Feb. 4, 2010

(54) Microwave Heating Apparatus

(76) Inventor: Arnaud Talpaert, Lesdain (FR)

Correspondence Address: WOMBLE CARLYLE SANDRIDGE & RICE, PLLC, ATTN: PATENT DOCKETING, P.O. BOX 7037, ATLANTA, GA, 30357-0037, US

(21) Appl. No.: 12/504,110

(22) Filed: Jul. 16, 2009

(30) Foreign Application Priority Data
Jul. 31, 2008 (EP) 08305440.3

(51) Int. Cl. H05B 6/80; B32B 5/00

(52) U.S. Cl. 219/730; 428/577

(57) ABSTRACT

A construct comprises a top panel, a bottom panel, and a pair of opposed side panels that define an interior space. The top panel includes a movable portion including a microwave energy interactive element on a side of the movable portion facing the interior space. The construct also includes a cross member adapted to extend at least partially across the movable portion for urging the movable portion toward the interior space.

### CROSS-REFERENCE TO RELATED APPLICATION

This application claims priority to European Patent Application No. 08305440.3, filed Jul. 31, 2008, which is incorporated by reference herein in its entirety.

### BACKGROUND

There is a continuing need for an improved construct or apparatus for heating, browning, and/or crisping a food item in a microwave oven.

### SUMMARY

This disclosure is directed generally to a construct or apparatus for heating, browning, and/or crisping a food item, for example, in a microwave oven, and a blank for forming such a construct. The construct and/or blank may include one or more microwave energy interactive elements that alter the effect of microwave energy on the food item, for example, a susceptor, a microwave energy shielding element, and/or a microwave energy distributing element.

The construct generally includes a plurality of adjoined panels arranged to define a cavity or interior space for receiving a food item. In one example, the construct comprises a top panel and a bottom panel in a substantially opposed, facing relationship, and a pair of side panels in a substantially opposed, facing relationship. The side panels are joined to the top panel and the bottom panel to define a sleeve having an interior space. The top panel includes a movable portion, for example, defined at least partially by one or more cuts (i.e., cut lines) in the top panel. The remaining portion of the top panel is a marginal portion that may at least partially circumscribe (i.e., surround) the movable portion. A susceptor may overlie at least a portion of the movable portion facing the interior space. The construct also may include a cross member that extends at least partially across the movable portion. The cross member is adapted to urge the movable portion away from the plane of the marginal portion towards the interior space to enhance heating, browning, and/or crisping of the food item. If desired, the cross member also may serve as a handle for the construct.

Other features, aspects, and embodiments of the invention will be apparent from the following description, accompanying figures, and appended claims.

### BRIEF DESCRIPTION OF THE DRAWINGS

The description refers to the accompanying drawings in which like reference characters refer to like parts throughout the several views, and in which:

FIG. 1A is a schematic perspective view of an exemplary construct or apparatus for heating, browning, and/or crisping a food item in a microwave oven;

FIG. 1B is a schematic perspective view of the construct of FIG. 1A, in a partially erected configuration;

FIG. 1C is a schematic top plan view of the construct of FIG. 1B;

FIG. 1D is a schematic bottom plan view of the construct of FIG. 1B;

FIGS. 1E and 1F are schematic plan views of the construct in an opened configuration; and

FIG. 1G is a schematic top plan view of a blank that may be used to form the construct of FIGS. 1A-1D.

### DESCRIPTION

Various aspects of the disclosure may be illustrated by referring to the figures. For purposes of simplicity, like numerals may be used to describe like features. It will be understood that where a plurality of similar features are depicted, not all of such features necessarily are labeled on each figure. Although several different exemplary aspects, implementations, and embodiments are provided, numerous interrelationships between, combinations thereof, and modifications of the various inventions, aspects, implementations, and embodiments are contemplated hereby.

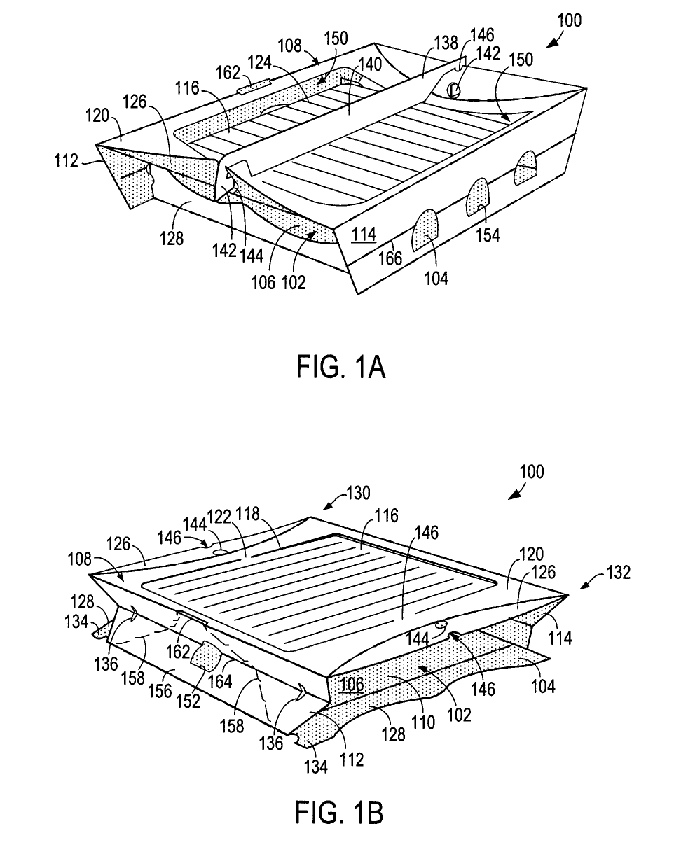

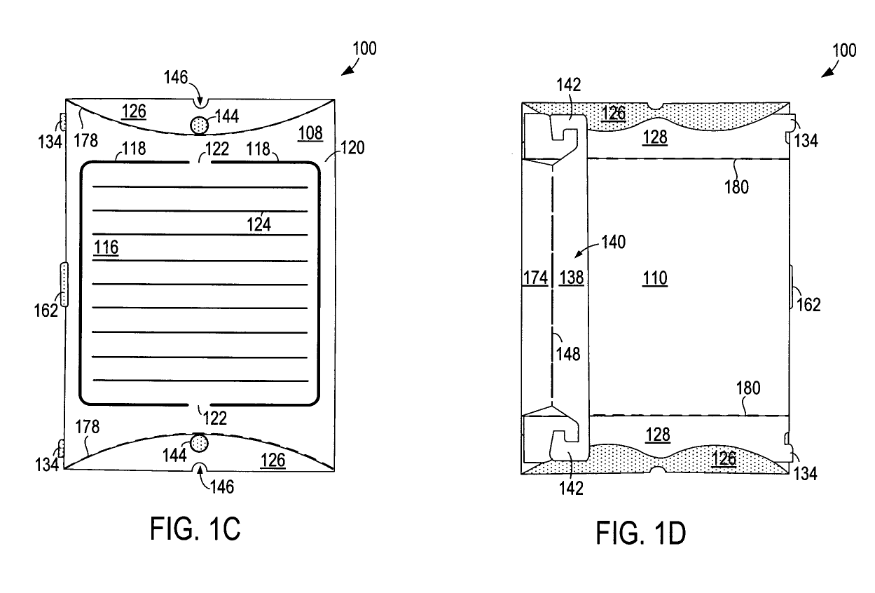

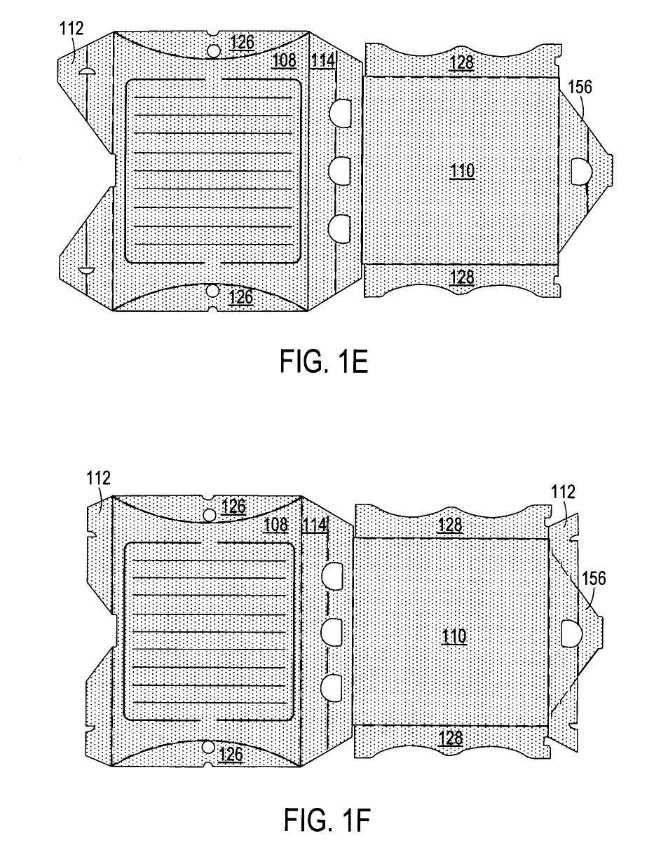

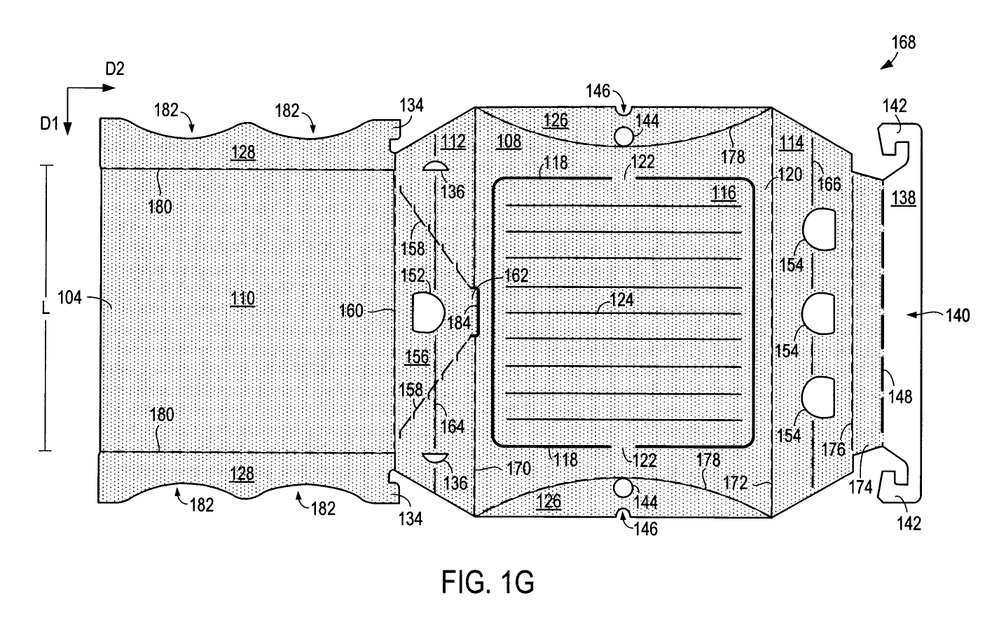

FIGS. 1A-1D schematically depict a construct or apparatus 100 for heating, browning, and/or crisping a food item in a microwave oven. The construct 100 generally includes a plurality of adjoined panels (discussed below) and an interior space or cavity 102 for receiving a food item (not shown), for example, a sandwich. A microwave energy interactive element 104, for example, a susceptor (schematically shown with stippling throughout the various figures), may overlie any of the various panels and/or at least partially define an interior surface 106 of the construct 100 facing the cavity 102. The construct 100 may be used to heat, brown, and/or crisp any suitable food item, for example, a sandwich, breaded meat item, or pastry. FIG. 1B schematically depicts the construct or apparatus 100 in a partially erected configuration. FIGS. 1C and 1D schematically respectively illustrate top and bottom plan views of the partially erected construct 100 of FIG. 1B in a substantially flattened state.

Now viewing FIGS. 1A-1D in further detail, the construct 100 includes a first pair of opposed panels (e.g., major panels) including a top panel 108 and a bottom panel 110, and a second pair of opposed panels (e.g., minor panels) including a first side panel 112 and a second side panel 114 that collectively define a sleeve having the interior space or cavity 102.

The top panel 108 includes a movable portion or “grilling” flap 116 defined by a pair of opposed cut lines (i.e., cuts), slits, or other lines of disruption 118. Each cut 118 has a generally U shape, and in this example, the U shape is somewhat squared, such that each cut may be said to have a somewhat squared U-shape. The flap 116 is pivotably joined to the remainder 120 of the top panel 108 (i.e., the marginal portion 120 of the top panel 108) at attachment areas 122 that serve as flex or pivot points or areas for the flap 116. In this example, the movable portion 116 is substantially centered in the top panel 108 such that the marginal portion of the top panel 108 at least partially circumscribes the movable portion 116. However, other shapes and configurations of the movable portion and marginal portion are contemplated. If desired, the flap 116 may include a plurality of score lines 124 that may define grill lines or marks on an adjacent food item, as will be discussed further below.

Still viewing FIGS. 1A-1D, a pair of top end panels 126 are foldably joined to opposite ends of the top panel 108. Likewise, a pair of bottom end panels 128 are foldably joined to opposite ends of the bottom panel 110. In the partially erected configuration shown in FIG. 1B, the top end panels 126 and respective bottom end panels 128 are in a substantially opposed, facing relationship with one another at opposed ends 130, 132 of the construct 100. With the ends 130, 132 in this open configuration, the food item to be heated, browned, and/or crisped may be inserted into the interior space 102. Alternatively, the food item may be inserted into the construct 100 at any other suitable time, for example, as the construct 100 is being erected from a blank 168 (discussed in connection with FIG. 1F).

When the food item is inside the construct 100, the bottom end panels 128 may be folded towards the interior space 102 to at least partially “close” the ends 130, 132 of the construct 100, as shown in FIG. 1A. The bottom end panels 128 each include a locking projection 134 adapted to be received within a respectively adjacent aperture 136 in the first side panel 112 (best seen in FIG. 1A) to maintain the bottom end panels 128 in a substantially upright “closed” configuration. While one example is shown in the figures, it will be understood that any type of locking feature may be used to secure the bottom end panels 128 in an upright configuration, and such features may be included in the end panels 128, the side panels 112, 114, or any suitable combination thereof.

The apparatus 100 may be provided with a cross member 138 (FIGS. 1A, 1D), which, in some embodiments, also may serve as a handle for the construct 100. The cross member 138 generally has a central or major portion 140 adapted to extend at least partially across the movable portion or grill flap 116, and pair of locking projections 142 at opposed ends of the cross member 138 adapted to be received within respective apertures 144 in the top end panels 126. If desired, each of the top end panels 126 may include a respective notch 146 to assist with maintaining the cross member 138 in a substantially straight and/or centered position between the sides (i.e., side panels 112, 114) of the construct 100, as shown in FIG. 1A.

The cross member 138 may be provided as a removably attached portion of the construct 100, for example, as shown in FIG. 1D, with the cross member 138 being joined to the remainder of the construct 100 along a line of separation or weakening (e.g., a tear line 148). In this example, the cross member 138 is in a facing, substantially contacting relationship with the bottom panel 110. However, the cross member 138 may be removably attached at any suitable location. As another example, the cross member 138 may be removably joined to the remainder of the construct 100 using an adhesive, for example, an adhesive dot or strip (not shown). Alternatively, the cross member 138 may be provided with, but separately from, the remainder of the construct 100.

To install the cross member 138 according to one acceptable method, the top end panels 126 may be urged upwardly and the locking projections 142 of the cross member 138 may be inserted into the respective apertures 144. In doing so, the major (i.e., central) portion 140 of the cross member 138 engages and urges the grill flap 116 away from the plane of the peripheral portion of the top panel 108 towards, and in some instances, into proximate or intimate contact with, the food item (not shown) in the cavity 102. As a further result, venting gaps 150 are formed between the grill flap 116 and the peripheral margin of the top panel 108 along slits 118 (FIG. 1A). The venting gaps 150 may allow the passage of moisture away from the food item during the heating cycle, thereby enhancing browning and/or crisping of the food item. Further, one or both of the side panels 112, 114 also may be provided with respective venting apertures 152, 154 (FIGS. 1A, 1B) to transport moisture away from the food item during heating.

Upon sufficient exposure to microwave energy, the susceptor 104 tends to convert at least a portion of the impinging microwave energy into thermal energy, which then can be transferred to the surface of the food item to enhance surface browning and/or crisping. The score lines 124 in the movable portion or “grilling” flap 116 may provide grill-type browning marks on the upper surface of the food item.

After heating, the food item may be removed from the microwave oven by grasping the cross member 138, which may be designed to be substantially transparent microwave energy so that it remains substantially cool to the touch after exposure to microwave energy. The food item then may be retrieved from the interior space 102 by removing the cross member 138 and/or opening one or both ends 130, 132 of the construct 100, for example, by removing the locking projections 142 from the respective apertures 144, and folding the bottom end panels 128 away from the cavity 102, or by any other suitable method.

If desired, the construct 100 may include one or more features that facilitate removal of the food item from the cavity 102. For example, as best seen in FIG. 1B, the construct 100 may include an access panel 156 that may be used to transform the construct 100 from an erected condition to a substantially open condition. In this example, the access panel 156 is defined by a pair of lines of disruption 158 in the first side panel 112 that extend divergently substantially from the top panel 108 towards the bottom panel 110 (or extend convergently from the bottom panel 110 towards the top panel 108). However, the access panel 156 may have any other shape or may be located in any other suitable location, as desired. If desired, the construct 100 may include a grasping feature, for example, a tab 162, extending from the access panel 156 to assist with initiating the separation of the access panel 156 from the remainder of the construct 100. The tab 162 may have any suitable shape.

In some embodiments, the construct 100 may include additional lines of weakening that facilitate opening of the construct 100. By way of example, in the illustrated embodiment, the construct 100 includes a line of disruption 158 joining the first side panel 112 to the bottom panel 110. At least a portion of the line of disruption 160, for example, at least the respective portions extending from the line of disruption 158 towards the ends 130, 132 of the construct 100 may include one or more cut lines. In doing so, when the access panel 156 is separated from the remainder of the first side panel 112, tearing may continue along line of disruption 160 until the ends 130, 132 are reached. As a result, the construct 100 may be completely opened into a somewhat flattened structure, as shown in FIG. 1E.

While one example of an unerected construct is shown in FIG. 1E, it will be appreciated that the precise manner in which the construct 100 is opened is not critical to the invention. For example, in some embodiments, the first side panel 112 and, optionally, the second side panel 114, may include respective lines of weakening (e.g., tear lines) 164, 166 (FIGS. 1A, 1B) that allow the construct 100 to be collapsed into a flattened configuration and/or to accommodate the shape of the food item. In such embodiments, such lines of weakening, for example, line of weakening 164 in the first side panel 112, also may facilitate opening of the construct 100 via the access panel 156. By way of example, FIG. 1F schematically illustrates the construct 100 in a fully open configuration after tearing along tear lines 158 and line of disruption 164.

FIG. 1G is a plan view of a blank 168 that may be used to form the construct 100 of FIGS. 1A-1E. The blank 168 generally includes a plurality of adjoined panels, each of which has a first dimension, for example, a length, extending in a first direction, for example, a longitudinal direction, D1, and a second dimension, for example, a width, extending in a second direction, for example, a transverse direction, D2. It will be understood that such designations are made only for convenience and do not necessarily refer to or limit the manner in which the blank 168 is manufactured or erected into a construct or apparatus.

Generally viewing FIG. 1G from left to right, the blank 168 includes a first major panel 110 joined to a first minor panel 112 along a longitudinal fold line 160. The first minor panel 112 is joined to a second major panel 108 along a longitudinal fold line 170, which in turn, is joined to a second minor panel 114 along a longitudinal fold line 172. The second minor 114 panel is joined to an attachment panel 174 along a longitudinal fold line 176, which in turn is joined to a detachable cross member panel or cross member 138 along a longitudinal line of disruption 148, which in this example, comprises a plurality of spaced apart cut lines. The cross member panel 138 includes a central portion 140 adjacent to fold line 148 and a pair of opposed locking features 142 extending from opposite longitudinal ends of the cross member panel 138. The attachment panel 174 has a length L approximately equal to the length L of the first major panel 110. In this example, the minor panels 112, 114 and attachment panel 174 are substantially trapezoidal in shape. However, other shapes are contemplated.

The second major panel 108 includes a movable portion 116 defined by a pair of opposed cut lines or slits 118. The movable portion 116 is joined to the marginal portion (i.e., the remainder) of the second major panel 108 at attachment areas 122. The movable portion 116 includes a plurality of score lines 124 extending transversely between, but typically not abutting, slits 118.

Still viewing FIG. 1G, the blank 168 includes a pair of end panels 126 joined to opposite (i.e., opposed) ends of the second major panel 112 along respective substantially arcuate, opposed fold lines 178. Each end panel 126 includes a substantially circular aperture 144 proximate to the midpoint or middle of the respective arcuate fold line 178, substantially aligned with attachment areas 122 of the movable portion 116 of the second major panel 108. Each aperture 144 is adapted to received the respectively adjacent locking feature 142 of the cross member 138 when the blank 168 is formed into a construct 100 (FIG. 1A). Further, each end panel 126 may include a substantially arcuate notch 146 along the outermost edge of the end panel 126 substantially aligned in the longitudinally direction with the respective aperture 144 (and with attachment areas 122). When the cross member 138 is installed, the notches 146 assist with maintaining the handle 138 in a substantially upright configuration with respect to the grilling flap 116, as shown in FIG. 1A.

A pair of end panels 128 is joined to opposite (i.e., opposed) ends of the first major panel 110 along respective transverse fold lines 180. Each end panel 128 extends generally in the transverse direction and includes a pair of inwardly arcuate cutouts or curved edge sections 182. Each end panel 128 also includes a locking projection 134 that extends toward the first minor panel 112. Each locking projection 134 is adapted to be received within a respective somewhat D-shaped locking aperture 136 in the first minor panel 112. The flat side of each locking aperture 136 is substantially aligned with the respectively adjacent transverse fold lines 180.

The first minor panel 112 and the second minor panel 114 each include respective venting apertures 152, 154. In this example, the apertures 152, 154 are substantially D-shaped with the rounded side of the apertures 152, 154 facing the second major panel 108 and the flattened side of the apertures 152, 154 substantially parallel to and adjacent to the respective longitudinal fold lines 160, 176. The first minor panel 112 and the second minor panel 114 also include a respective longitudinal line of disruption 164, 166 extending substantially along the length of the respective minor panel 112, 114, interrupted by the respective venting apertures 152, 154.

The first minor panel 112 also includes a pair of lines of disruption (e.g. tear lines or cut lines) 158 that extend divergently from a somewhat square U-shaped slit 184 in the second major panel 108 and terminate substantially proximate to fold line 160. The slit defines a tab 162 that is struck from the second major panel 108 when the blank 168 is formed into a construct 100, as shown in FIGS. 1B, 1C, 1D. In this example, the lines of disruption 158 are “zipper” type tear lines (i.e., a plurality of cut lines, each of which includes a substantially linear portion and an oblique portion extending from the respective linear portion). However, other types of tear lines or cut lines may be used. Further, it will be understood that although the illustrated example includes particular types of lines of weakening or disruption in particular portions of the blank and/or construct, the various other panels of the blank and/or construct may include such lines of weakening and/or numerous other features that facilitate manufacture, assembly, use, and/or opening of the construct.

A microwave energy interactive element, for example, a susceptor 104 (schematically illustrated with stippling) overlies at least a portion of one side of the blank 168, for example, a first side of the blank 168 intended to become the interior side or surface 106 of the construct 100 (FIGS. 1A-1D) formed from the blank 168. In this example, the susceptor 104 overlies the entire blank 168 except the cross member or handle panel 138, so that when the cross member 138 is used as a handle, the handle 138 remains substantially cool, even after exposure to microwave energy. However, it is contemplated that other areas that would be desirable to remain cool and/or areas not needed for browning and/or crisping may be provided without a susceptor. For example, in some embodiments, end panels 126 and/or tab 162 may be provided without a susceptor.

To form the construct 100 from the blank 168 according to one exemplary method, the blank 168 may be folded along longitudinal fold lines 160, 170, 172, 176, and major panel 110 may be brought into a superposed configuration with major panel 108. The attachment panel 174 and cross member panel 138 then may be brought into an overlapping, substantially contacting relationship with the second side (i.e. exterior side) of major panel 110 (FIG. 1D). The attachment panel 174 then may be joined to the major panel 110 using any suitable adhesive, thermal, or mechanical technique or mechanism, leaving the cross member 138 free to be separated from the attachment panel 174 along line of disruption 148 (FIG. 1D). If desired, the construct 100 may be folded along fold lines 164, 166 to allow the construct 100 to be somewhat compressed or flattened, as shown in FIG. 1B.

Numerous materials may be suitable for use in forming the various blanks and constructs (e.g. trays) of the invention, provided that the materials are resistant to softening, scorching, combusting, or degrading at typical microwave oven heating temperatures, for example, from about 250° F. to about 425° F. Such materials may include microwave energy interactive materials and microwave energy transparent or inactive materials.

The microwave energy interactive material(s) may be used to form one or more microwave energy interactive elements or features that alter the effect of microwave energy on the adjacent food item. Each microwave energy interactive element comprises one or more microwave energy interactive materials or segments arranged in a particular configuration to absorb microwave energy, transmit microwave energy, reflect microwave energy, or direct microwave energy, as needed or desired for a particular microwave heating construct and food item. The microwave energy interactive element may be configured to promote browning and/or crisping of a particular area of the food item, to shield a particular area of the food item from microwave energy to prevent scorching or overheating, or to transmit microwave energy towards or away from a particular area of the food item.

In the illustrated example, the blank 168 includes a susceptor 104 substantially overlying and joined to at least a portion of the blank 168 that forms or defines at least a portion of a first surface 106, which may serve as a food-contacting or food bearing surface in proximate or intimate contact with the food item. If desired, a second surface opposite the first surface (i.e., the exterior surface) also may include one or more microwave energy interactive elements.

The susceptor generally comprises a thin layer of microwave energy interactive material (generally less than about 100 angstroms in thickness, for example, from about 60 to about 100 angstroms in thickness, and having an optical density of from about 0.15 to about 0.35, for example, about 0.21 to about 0.28) that tends to absorb at least a portion of impinging microwave energy and convert it to thermal energy (i.e., heat) at the interface with the food item. Susceptor elements often are used to promote browning and/or crisping of the surface of a food item. However, other microwave energy interactive elements, such as those described herein, are contemplated for use with the invention.

For example, the microwave energy interactive element may comprise a foil having a thickness sufficient to reflect substantially all of impinging microwave energy. Such reflective elements may be formed from various materials and may have various configurations, depending on the particular application for which the shielding element is used. Typically, such elements are formed from a conductive, reflective metal or metal alloy, for example, aluminum, copper, or stainless steel. Such elements may have a thickness of from about 0.000285 inches to about 0.05 inches, for example, about 0.0003 inches to about 0.03 inches, for example, about 0.00035 inches to about 0.020 inches, for example, about 0.016 inches.

Larger microwave energy reflecting elements may be used as microwave energy shielding elements, for example, where all or a portion of the food item is prone to scorching or drying out during heating. Smaller microwave energy reflecting elements may be used to diffuse or lessen the intensity of microwave energy. A plurality of smaller microwave energy reflecting elements also may be arranged to form a microwave energy directing element to direct microwave energy to specific areas of the food item. If desired, the loops may be of a length that causes microwave energy to resonate, thereby enhancing the distribution effect. Microwave energy distributing elements are described in U.S. Pat. Nos. 6,204,492, 6,433,322, 6,552,315, and 6,677,563, each of which is incorporated by reference in its entirety.

If desired, any of the numerous microwave energy interactive elements described herein or contemplated hereby may be substantially continuous, that is, without substantial breaks or interruptions, or may be discontinuous, for example, by including one or more microwave energy transparent areas or apertures that transmit microwave energy therethrough. Such areas may be sized and positioned to heat particular areas of the food item selectively. The areas may extend through the entire structure, or only through one or more layers. The number, shape, size, and positioning of such microwave energy transparent areas may vary for a particular application depending on type of construct being formed, the food item to be heated therein or thereon, the desired degree of shielding, browning, and/or crisping, whether direct exposure to microwave energy is needed or desired to attain uniform heating of the food item, the need for regulating the change in temperature of the food item through direct heating, and whether and to what extent there is a need for venting.

It will be understood that the aperture may be a physical aperture or void in one or more layers or materials used to form the construct, or may be a non-physical “aperture”. A non-physical aperture is a microwave energy transparent area that allows microwave energy to pass through the structure without an actual void or hole cut through the structure. Such areas may be formed by simply not applying microwave energy interactive material to the particular area, or by removing microwave energy interactive material in the particular area, or by mechanically deactivating the particular area (rendering the area electrically discontinuous). Alternatively, the areas may be formed by chemically deactivating the microwave energy interactive material in the particular area, as described in U.S. Pat. No. 4,865,921, thereby transforming the microwave energy interactive material in the area into a substance that is transparent to microwave energy (i.e., microwave energy inactive). While both physical and non-physical apertures allow the food item to be heated directly by the microwave energy, a physical aperture also provides a venting function to allow steam or other vapors to escape from the interior of the construct. The arrangement of microwave energy interactive and microwave energy transparent areas may be selected to provide various levels of heating, as needed or desired for a particular application.

The arrangement of microwave energy interactive and microwave energy transparent areas may be selected to provide various levels of heating, as needed or desired for a particular application. For example, where greater heating is desired, the total inactive area may be increased. In doing so, more microwave energy is transmitted to the food item. Alternatively, by decreasing the total inactive area, more microwave energy is absorbed by the microwave energy interactive areas, converted into thermal energy, and transmitted to the surface of the food item to enhance browning and/or crisping.

In some instances, it may be beneficial to create one or more discontinuities or inactive regions to prevent overheating or charring of the construct. By way of example, and not limitation, in the construct 100 illustrated in FIGS. 1A-1D, the attachment panel 174 is an overlapping relationship with major panel 110. When exposed to microwave energy, the concentration of heat generated by the overlapped panels may be sufficient to cause the underlying support, in this case, paperboard, to become scorched. As such, the overlapping portions of one or both of panels 110, 174 may be designed to be microwave energy transparent, for example, by forming these areas of the blank 168 without a microwave energy interactive material, by removing any microwave energy interactive material that has been applied, or by deactivating the microwave energy interactive material in these areas.

Further still, one or more panels, portions of panels, or portions of the construct may be designed to be microwave energy inactive to ensure that the microwave energy is focused efficiently on the areas to be browned and/or crisped, rather than being lost to portions of the food item not intended to be browned and/or crisped or to the heating environment. This may be achieved using any suitable technique, such as those described above. By way of example, and not limitation, in the illustrated example, the top end panels 126 are in a substantially vertical configuration extending upwardly away from the interior space 102 in which the food item is heated. In this configuration, the top end panels 126 are not likely to be in proximate or intimate contact with any portion of the food item intended to be browned and/or crisped. Likewise, tab 162 may be made to be microwave energy transparent if desired.

If desired, the microwave energy interactive element may be supported on a microwave inactive or transparent substrate, for example, a polymer film or other suitable polymeric material, for ease of handling and/or to prevent contact between the microwave energy interactive material and the food item. As used herein the term “polymer” or “polymeric material” includes, but is not limited to, homopolymers, copolymers, such as for example, block, graft, random, and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic, and random symmetries.

Examples of polymer films that may be suitable include, but are not limited to, polyolefins, polyesters, polyamides, polyimides, polysulfones, polyether ketones, cellophanes, or any combination thereof. Other non-conducting substrate materials such as paper and paper laminates, metal oxides, silicates, cellulosics, or any combination thereof, also may be used.

In one particular example, the polymer film comprises polyethylene terephthalate. Examples of polyethylene terephthalate films that may be suitable for use as the substrate include, but are not limited to, MELINEX®, commercially available from DuPont Teijan Films (Hopewell, Va.), and SKYROL, commercially available from SKC, Inc. (Covington, Ga.). Polyethylene terephthalate films are used in commercially available susceptors, for example, the QWIKWAVE® Focus susceptor and the MICRORITE® susceptor, both available from Graphic Packaging International (Marietta, Ga.).

The thickness of the film generally may be from about 35 gauge to about 10 mil. In each of various examples, the thickness of the film may be from about 40 to about 80 gauge, from about 45 to about 50 gauge, about 48 gauge, or any other suitable thickness.

The microwave energy interactive material may be applied to the substrate in any suitable manner, and in some instances, the microwave energy interactive material is printed on, extruded onto, sputtered onto, evaporated on, or laminated to the substrate. The microwave energy interactive material may be applied to the substrate in any pattern, and using any technique, to achieve the desired heating effect of the food item.

For example, the microwave energy interactive material may be provided as a continuous or discontinuous layer or coating including circles, loops, hexagons, islands, squares, rectangles, octagons, and so forth. Examples of various patterns and methods that may be suitable are provided in U.S. Pat. Nos. 6,765,182; 6,717,121; 6,677,563; 6,552,315; 6,455,827; 6,433,322; 6,414,290; 6,251,451; 6,204,492; 6,150,646; 6,114,679; 5,800,724; 5,759,422; 5,672,407; 5,628,921; 5,519,195; 5,424,517; 5,410,135; 5,354,973; 5,340,436; 5,266,386; 5,260,537; 5221,419; 5,213,902; 5,117,078; 5,039,364; 4,963,424; 4,936,935; 4,890,439; 4,775,771; 4,865,921; and Re. 34,683. Although particular examples of patterns of microwave energy interactive material are shown and described herein, it should be understood that other patterns of microwave energy interactive material are contemplated by the present disclosure.

The microwave energy interactive material may be an electroconductive or semiconductive material, for example, a metal or a metal alloy provided as a metal foil; a vacuum deposited metal or metal alloy; or a metallic ink, an organic ink, an inorganic ink, a metallic paste, an organic paste, an inorganic paste, or any combination thereof. Examples of metals and metal alloys that may be suitable for use with the present invention include, but are not limited to, aluminum, chromium, copper, inconel alloys (nickel-chromium-molybdenum alloy with niobium), iron, magnesium, nickel, stainless steel, tin, titanium, tungsten, and any combination or alloy thereof.

Alternatively, the microwave energy interactive material may comprise a metal oxide. Examples of metal oxides that may be suitable for use with the present invention include, but are not limited to, oxides of aluminum, iron, and tin, used in conjunction with an electrically conductive material where needed. Another example of a metal oxide that may be suitable for use with the present invention is indium tin oxide (ITO). ITO can be used as a microwave energy interactive material to provide a heating effect, a shielding effect, a browning and/or crisping effect, or a combination thereof. For example, to form a susceptor, ITO may be sputtered onto a clear polymer film. The sputtering process typically occurs at a lower temperature than the evaporative deposition process used for metal deposition. ITO has a more uniform crystal structure and, therefore, is clear at most coating thicknesses. Additionally, ITO can be used for either heating or field management effects. ITO also may have fewer defects than metals, thereby making thick coatings of ITO more suitable for field management than thick coatings of metals, such as aluminum.

Alternatively still, the microwave energy interactive material may comprise a suitable electroconductive, semiconductive, or non-conductive artificial dielectric or ferroelectric. Artificial dielectrics comprise conductive, subdivided material in a polymeric or other suitable matrix or binder, and may include flakes of an electroconductive metal, for example, aluminum.

The various blanks and/or constructs contemplated hereby may be formed according to numerous processes known to those in the art, including using adhesive bonding, thermal bonding, ultrasonic bonding, mechanical stitching, or any other suitable process. Any of the various layers that may be used to form the structures and/or constructs of the invention may be provided as a sheet of material, a roll of material, a die cut material in the shape of the construct to be formed (e.g., a blank), or in any other suitable form.

The blank and/or construct may be formed from any suitable dimensionally stable material, for example, coated paperboard or a similar material. For example, the paperboard may have a basis weight of from about 60 to about 330 lbs/ream, for example, from about 80 to about 140 lbs/ream. The paperboard generally may have a thickness of from about 6 to about 30 mils, for example, from about 10 to about 28 mils. In one particular example, the paperboard has a thickness of about 12 mils. Any suitable paperboard may be used, for example, a solid bleached or solid unbleached sulfate board, such as SUS® board, commercially available from Graphic Packaging International.

The blank and/or construct can also be constructed of other materials, such as cardboard, hard paper, or any other material having properties suitable for enabling the package to function at least generally as described above. The blank and/or construct can also be laminated to or coated with one or more sheet-like materials at selected panels or panel sections.

Optionally, one or more portions, panels, or sections of the various blanks and/or constructs described herein or contemplated hereby may be coated with varnish, clay, or other materials, either alone or in combination. The coating may then be printed over with product advertising, graphics, or other information or indicia. The blanks and/or constructs also may be coated to protect any information printed thereon. Furthermore, the blanks and/or constructs may be coated with, for example, a moisture barrier layer, on either or both sides.

Alternatively or additionally, any of the blanks and/or constructs of the present invention may be coated or laminated with other materials to impart other properties, such as absorbency, repellency, opacity, color, printability, stiffness, or cushioning. For example, absorbent susceptors are described in U.S. Provisional Application No. 60/604,637, filed Aug. 25, 2004, and U.S. Patent Application Publication No. US 2006/0049190 A1, published Mar. 9, 2006.

Although certain embodiments of this invention have been described with a certain degree of particularity, those skilled in the art could make numerous alterations without departing from the spirit or scope of this invention. Any directional references (e.g., upper, lower, upward, downward, left, right, leftward, rightward, top, bottom, above, below, vertical, horizontal, clockwise, and counterclockwise) are used only for identification purposes to aid the reader's understanding of various embodiments, and do not create limitations, particularly as to the position, orientation, or use of the invention unless specifically set forth in the claims. Joinder references (e.g., joined, attached, coupled, connected, and the like) are to be construed broadly and may include intermediate members between a connection of elements and relative movement between elements. As such, joinder references do not necessarily imply that two elements are connected directly and in fixed relation to each other.

It will be understood that in each of the various blanks and packages contemplated hereby, a “fold line” can be any substantially linear, although not necessarily straight, form of weakening that facilitates folding therealong. More specifically, but not for the purpose of narrowing the scope of the present invention, a fold line may be a score line, such as lines formed with a blunt scoring knife, or the like, which creates a crushed portion in the material along the desired line of weakness, a cut that extends partially into a material along the desired line of weakness, and/or a series of cuts that extend partially into and/or completely through the material along the desired line of weakness, or any combination of these features.

For example, one type of conventional tear line is in the form of a series of cuts that extend completely through the material, with adjacent cuts being spaced apart slightly so that a nick (e.g., a small somewhat bridging-like piece of the material) is defined between the adjacent cuts for typically temporarily connecting the material across the tear line. The nicks are broken during tearing along the tear line. Such a tear line that includes nicks can also be referred to as a cut line, since the nicks typically are a relatively small percentage of the subject line, and alternatively the nicks can be omitted from such a cut line.

It will be recognized by those skilled in the art, that various elements discussed with reference to the various embodiments may be interchanged to create entirely new embodiments coming within the scope of the present invention. It is intended that all matter contained in the above description or shown in the accompanying drawings shall be interpreted as illustrative only and not limiting. Changes in detail or structure may be made without departing from the spirit of the invention. The detailed description set forth herein is not intended nor is to be construed to limit the present invention or otherwise to exclude any such other embodiments, adaptations, variations, modifications, and equivalent arrangements of the present invention.

Accordingly, it will be readily understood by those persons skilled in the art that, in view of the above detailed description of the invention, the present invention is susceptible of broad utility and application. Many adaptations of the present invention other than those herein described, as well as many variations, modifications, and equivalent arrangements will be apparent from or reasonably suggested by the present invention and the above detailed description thereof, without departing from the substance or scope of the present invention.

While the present invention is described herein in detail in relation to specific aspects, it is to be understood that this detailed description is only illustrative and exemplary of the present invention and is made merely for purposes of providing a full and enabling disclosure of the present invention and to set forth the best mode of practicing the invention known to the inventors at the time the invention was made. The detailed description set forth herein is not intended nor is to be construed to limit the present invention or otherwise to exclude any such other embodiments, adaptations, variations, modifications, and equivalent arrangements of the present invention.

What is claimed is:

1. A construct comprising:
a top panel and a bottom panel in a substantially opposed, facing relationship, the top panel including a movable portion defined at least partially by a pair of opposed cuts in the top panel;
a pair of side panels joined to the top panel and the bottom panel for defining an interior space;
a susceptor overlying at least a portion of the movable portion of the top panel on a side of the movable portion facing the interior space; and
a cross member adapted to
extend at least partially across the movable portion, and
urge the movable portion toward the interior space.

2. The construct of claim 1, wherein the cuts defining the movable portion are U-shaped.

3. The construct of claim 1, wherein each cut of the pair the cuts defining the movable portion has a somewhat squared U-shape.

4. The construct of claim 1, further comprising a pair of top end panels respectively joined to opposite ends of the top panel.

5. The construct of claim 4, further comprising an aperture in each of the top end panels.

6. The construct of claim 5, wherein
the cross member includes a central portion and a pair of locking features at opposed ends of the cross member, and
the locking features are adapted to respectively engage the apertures in the top end panels.

7. The construct of claim 1, wherein the top panel further includes a marginal portion at least partially circumscribing the movable portion.

8. The construct of claim 7, wherein
in a first configuration, the movable portion substantially lies in a plane with the marginal portion of the top panel, and
in a second configuration with the locking features engaging the respective apertures in the top end panels, the movable portion is urged away from the plane of the marginal portion.

9. The construct of claim 1, wherein the cross member is removably joined to the bottom panel.

10. The construct of claim 1, further comprising a pair of bottom end panels respectively joined to opposite ends of the bottom panel.

11. The construct of claim 1, further comprising a tear line in at least one of the adjoined panels, wherein the tear line at least partially defines an access panel.

12. A blank for forming a microwave heating construct, comprising:
a plurality of adjoined panels, each of the adjoined panels having a first dimension extending in a first direction and a second dimension extending in a second direction substantially perpendicular to the first direction, the plurality of adjoined panels including
a first major panel,
a first minor panel joined to the first major panel along a fold line extending in the first direction,
a second major panel joined to the first minor panel along a fold line extending in the first direction, the second major panel including a movable portion defined at least partially by a pair of opposed cuts, and
a cross member panel separably joined to at least one of the adjoined panels; and
a susceptor overlying the movable portion of the second major panel.

13. The blank of claim 12, wherein the cuts defining the movable portion are U-shaped.

14. The blank of claim 12, the adjoined panels further including
a first pair of opposed end panels joined to the first major panel along respective arcuate fold lines extending in the second direction, and
a second pair of opposed end panels joined to the second major panel along respective fold lines extending in the second direction.

15. The blank of claim 12, further comprising a pair of tear lines in the first minor panel extending substantially between the first major panel and the second major panel.

16. The blank of claim 12, the adjoined panels further including a second minor panel joined to the second major panel along a fold line extending in the first direction.

17. The blank of claim 12, the adjoined panels further including an attachment panel joined to the second minor panel along a fold line extending in the first direction, wherein the cross member panel is separably joined to the attachment panel along a tear line.

18. A method of heating, browning, and/or crisping a food item in a microwave oven, comprising:
providing a construct including
a top panel and a bottom panel in a substantially opposed, facing relationship, the top panel including a movable portion, a pair of side panels joined to the top panel and the bottom panel for defining an interior space,
a susceptor overlying at least a portion of the movable portion of the top panel on a side of the movable portion facing the interior space, and
a cross member;
inserting a food item in the interior space, the food item having at least one surface intended to be browned and/or crisped, the surface of the food item being adjacent to the susceptor; and
configuring the cross member to extend at least partially across the movable portion, thereby engaging the movable portion and urging the movable portion toward the interior space.

19. The method of claim 18, wherein the movable portion is defined at least partially by a pair of opposed cuts in the top panel.

20. The method of claim 18, wherein the cuts defining the movable portion are U-shaped.

21. The method of claim 18, further comprising exposing the food item within the interior space to microwave energy, whereby the susceptor overlying the movable portion converts at least a portion of the microwave energy into thermal energy to brown and/or crisp the surface of the food item.

22. The method of claim 18, wherein
the construct further includes a pair of top end panels respectively joined to opposite ends of the top panel, and
configuring the cross member to extend at least partially across the movable portion comprises engaging the top end panels.

23. The method of claim 22, wherein
the cross member includes a pair of locking features at opposite ends of the cross member,
each top end panel includes an aperture, and
configuring the cross member to extend at least partially across the movable portion comprises mating the locking features with the apertures.

24. The method of claim 23, wherein the cross member includes a central portion disposed between the locking features, and configuring the cross member to extend at least partially across the movable portion comprises engaging the movable portion with the central portion of the cross member.

25. The method of claim 18, wherein
the construct includes an access panel defined by a plurality of tear lines, and
the method further comprises opening the access panel along the plurality of tear lines and removing the food item from the interior space.
